(19) United States
(12) Patent Application Publication
(10) Pub. No.: US 2019/0354815 A1
(43) Pub. Date: Nov. 21, 2019

(54) Homeostatic Capacity Evaluation of Artificial Intelligence Systems

(71) Applicant: Palo Alto Investors LP, Palo Alto, CA (US)

(72) Inventors: Conrad Minkyoo Yun, San Mateo, CA (US); Anthony Joonkyoo Yun, Menlo Park, CA (US)

(21) Appl. No.: 16/411,767

(22) Filed: May 14, 2019

Related U.S. Application Data
(60) Provisional application No. 62/671,790, filed on May 15, 2018.

(51) Int. Cl. G06K 9/62; G06N 3/08; G06N 7/00; G06N 3/04

(52) U.S. Cl. CPC G06K 9/6277; G06N 3/049; G06N 7/005; G06N 3/082

(57) ABSTRACT

Methods of evaluating homeostatic capacity of an artificial intelligence system are provided. Aspects of the methods include obtaining dynamic functional data from the artificial intelligence system; and evaluating the homoeostatic capacity of the artificial intelligence system from the dynamic functional data. Also provided are devices configured for use in practicing the methods.

### CROSS-REFERENCE TO RELATED APPLICATIONS

Pursuant to 35 U.S.C. § 119 (e), this application claims priority to the filing date of U.S. Provisional Patent Application Ser. No. 62/671,790 filed May 15, 2018; the disclosure of which application is herein incorporated by reference.

### INTRODUCTION

Artificial intelligence is the “cognitive” function of machines or software. Artificial intelligence refers to the ability of a machine or computer program to problem-solve and act to accomplish a goal after perceiving its environment. The study of artificial intelligence focuses on how machines may be used to model, simulate, and imitate human intelligence and perform tasks that normally require human intelligence such as decision-making, speech recognition, visual perception, etc. The development of artificial intelligence draws upon a variety of disciplines such as computer science, philosophy, mathematics, psychology, linguistics, engineering, robotics and psychology.

The field of artificial intelligence is concerned with technologies that can perform capabilities normally requiring human intelligence. Various goals include, for example, knowledge reasoning, natural language processing, machine learning, computer vision, pattern recognition, and general intelligence. Emerging capabilities of artificial intelligence technologies include speech comprehension, machine learning, deep learning, autonomous driving, playing in strategic game systems, intelligent routing in a content delivery network, and military simulations. Further capabilities include finding problems, determining the probability of future events, finding non-obvious patterns, and optimization of processes.

Artificial intelligence has progressed in recent years due to improvements in computing power and storage. Various technologies that have enabled the growth in artificial intelligence tools include, for example, advancements in big data analytics, neural networks, parallel processing, cloud technology, computer vision, audio processing, natural language processing, and inference engines.

### SUMMARY

Methods of evaluating homeostatic capacity of an artificial intelligence system are provided. Aspects of the methods include obtaining dynamic functional data from the artificial intelligence system; and evaluating the homoeostatic capacity of the artificial intelligence system from the dynamic functional data. Also provided are devices configured for use in practicing the methods.

### BRIEF DESCRIPTION OF THE FIGURES

FIG. 1 is a flow chart illustrating one embodiment of a method for evaluating homeostatic capacity of a system.

FIG. 2 is a flow chart illustrating one embodiment of a method for evaluating homeostatic capacity of a system, specifically showing a machine learning algorithm used in classification.

### DETAILED DESCRIPTION

Methods of evaluating homeostatic capacity of an artificial intelligence system are provided. Aspects of the methods include obtaining dynamic functional data from the artificial intelligence system; and evaluating the homoeostatic capacity of the artificial intelligence system from the dynamic functional data. Also provided are devices configured for use in practicing the methods.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

In further describing the invention, aspects of embodiments of methods of evaluating homeostatic capacity of an artificial intelligence system are described first in greater detail, followed by a description of representative devices that find use in practicing such methods. Next, a review of various applications in which the methods and devices find use, is provided.

### Methods of Homeostatic Capacity Evaluation

As summarized above, methods for evaluating homeostatic capacity of an artificial intelligence system are provided. Homeostatic capacity refers to the ability of the artificial intelligence system to maintain relatively constant conditions in the internal environment while continuously interacting with and adjusting to changes originating within or outside the system. By “evaluating” is meant assessing, analyzing or assaying to provide a form of measurement, e.g., in the form of a determination or proxy thereof, of the homeostatic capacity of the artificial intelligence system. The evaluations that may be made may be quantitative and/or qualitative determinations, and be represented as a value or set of values, as desired.

Aspects of the methods include obtaining dynamic functional data from an artificial intelligence system. The phrase “dynamic functional data” is employed to refer to a measure of a functional parameter of the artificial intelligence system. The functional parameter which is employed in methods of the invention to obtain the dynamic functional data may be a parameter that provides information about one or more of a system's functions. For example, in the context of autonomous vehicles, e.g., as described in greater detail below, dynamic functional data may be a parameter that includes, but is not limited to: the ability to steer in certain weather conditions, the ability to stop based on the distance from an object, the ability to discern objects based on light/dark conditions, the ability to project trajectory of an object in the environment; etc.

Accordingly, in some embodiments, dynamic functional data may include an evaluation of the system during and/or after the performance of a task for which one or more of the assessed parameters is required. For example, in the context of autonomous vehicles, e.g., as described in greater detail below, the parameter may be assessed during and/or after performance of a task, such assessing the ability to steer during the performance of a steering task, assessing the ability to stop during a stopping task, assessing the ability to discern objects during an objection identification task, assessing the ability to project trajectory of an object during an object trajectory projection task; etc. In some embodiments, a task during which a parameter is assessed is a standardized task, and, for example, reference values for the parameter assessed during the standardized task may be available. In some embodiments, a task during which a parameter is assessed is a task performed during normal use and/or operation of the system, and, for example, reference values for the parameter assessed during the task may not be available.

Functional parameters that are measured may vary widely and may include quantitative and/or qualitative assessments of essentially any useful and appropriate function of a system, where examples of such parameters include, but are not limited to, those described above, and the like, and combinations thereof. Dynamic functional data may be made up of information about a single type of functional parameter, or two or more different types of functional parameters. The dynamic functional data employed in methods of the invention may thus be made up of information obtained by measuring or assessing one or more functional parameters, such as the ones listed above.

As summarized above, the functional data that is obtained and employed in methods of the invention is dynamic functional data. By “dynamic functional data” is meant functional data that incorporates some type of change component, as opposed to static functional data. The change component may vary widely, where examples of change components include, but are not limited to components that are: temporal and/or in response to an applied stimulus and/or in response to withdrawal of stimulus and/or in response to a change in the contextual environment of the system.

For example, the dynamic functional data that is obtained may be functional data obtained over a given period of time. The given period of time may vary, ranging in some instances from 0.1 seconds or less to 24 hours or more, such as 0.1 seconds to 1 second or 1 second to 12 hours, e.g., 1 second to 1 hour, including 1 second to 1 minute, 1 second to 10 seconds, 10 seconds to 1 minute, 30 seconds to 1 minute, 1 minute to 5 minutes, 1 minute to 10 minutes, 1 minute to 30 minutes, 10 minutes to 1 hour, 30 minutes to 1 hour, 45 minutes to 1 hour, etc.

Where the dynamic functional data is data obtained over a given period of time, the data may be obtained continuously over that period of time or at one or more distinct points during that period of time. For example, the functional parameter(s) that is monitored in order to obtain dynamic functional data may be monitored continuously during the given period of time, i.e., it may be obtained in an uninterrupted manner, i.e., without cessation, during the given period of time.

Alternatively, the functional parameter(s) that is monitored in order to obtain dynamic functional data may be monitored intermittently during the given period of time, i.e., it may be obtained at one or more points over the given period of time, with an interval between points at which it is not obtained. In some embodiments, the interval may vary, ranging, for example, from 0.01 sec to 60 minutes or longer, such as 0.1 to 60 s, 0.1 s to 1 s, 0.01 s to 1 s, 0.01 s to 0.1 s, 1 s to 30 s, 1 s to 15 s, 1 s to 10 s, 1 s to 5 s, 1 s to 2 s, etc. The number and/or frequency of such intervals within the period of time may correspondingly vary, ranging, for example, from 1 interval to 1000 intervals or more within the period of time, such as e.g., 1 to 1000 intervals, 1 to 500 intervals, 1 to 100 intervals, 1 to 50 intervals, 1 to 10 intervals, 1 to 5 intervals, 10 to 1000 intervals, 10 to 500 intervals, 10 to 100 intervals, 10 to 50 intervals, 100 to 1000 intervals, 100 to 500 intervals, etc.

As summarized above, dynamic functional data may include a temporal change component. A temporal change component of dynamic functional data may include essentially any change in a functional parameter that occurs, or is expected to occur, as a function of time, including where such change does or does not also involve an applied stimulus and/or withdrawal of a stimulus and/or a change in the contextual environment of the system. For example, in some instances, a change in a functional parameter that occurs, or is expected to occur, as a function of time may be influenced by or due to one or more factors, such as wear-and-tear on the system, accumulation of data and/or reduction in storage capacity, software updates, etc.

A system with a high homeostatic capacity will have an enhanced ability to maintain normal operating performance in the presence of one or more factors that may contribute to the temporal change component of dynamic functional data as compared to a system with low homeostatic capacity. Accordingly, a system with a low homeostatic capacity may be described as having a decreased ability to maintain normal operating performance in the presence of one or more factors that may contribute to the temporal change component of dynamic functional data as compared to a system with high homeostatic capacity. In some instances, the homeostatic capacity of a system may change over time. For example, in some instances, the homeostatic capacity of a system may decrease such that, after some period of time, the system is less capable of maintaining normal operating performance as compared to before the period of time. In some instances, the homeostatic capacity of a system may increase such that, after some period of time, the system is more capable of maintaining normal operating performance as compared to before the period of time.

Changes in homeostatic capacity over time of an artificial intelligence system, including increases and/or decreases in homeostatic capacity of the system, may be assessed using multiple evaluations of homeostatic capacity as described herein performed over time or constant monitoring of homeostatic capacity. In some instances, the homeostatic capacity of a system at a later timepoint may represent an increase or decrease, as compared to the homeostatic capacity of the system at an earlier timepoint, where such increase or decrease may range from at least 1% to at least 50%, including e.g., at least 1%, at least 5%, at least 10%, at least 20%, etc. For example, where a standardized task is employed, an evaluation described herein may reveal a 10% decrease in homeostatic capacity of the system at a later timepoint as compared to an earlier, or baseline, timepoint of completing the standardized task. In some instances, the homeostatic capacity of a system may be maintained over time, including e.g., where the evaluated homeostatic capacity is essentially equal at two temporally separated timepoint.

In some instances, a derivative, such as a first, second or third derivative, of initial functional data may be employed as the dynamic functional data. For example, the dynamic functional data may be obtained by evaluating a functional parameter for a rate of change over a period of time. As such, methods may include obtaining information about the speed at which a functional parameter of interest changes over a given period of period of time. Obtaining dynamic functional data as described above provides for numerous benefits, including increases in temporal resolution, as compared to single point in time data. Dynamic functional data as obtained herein provides a truer and more meaningful measure of the functional value(s) of interest, as compared to single point in time measurements.

Dynamic functional data of interest also includes functional data that is obtained by evaluating a functional parameter for a change in response to an applied stimulus. Such functional data may include data that is obtained before and/or after application of the stimulus to the system. In some instances, the functional data may be obtained over a given period of time that spans or follows the application of the stimulus to the system. This type of functional data may be viewed as functional data that is obtained over a given period of time in conjunction with application of a stimulus to the system being evaluated.

The applied stimulus may vary, where stimuli of interest include input stimuli and sensed stimuli. In the context of an enterprise security Al system, the input stimuli could be a series of system failures within an enterprise such as power outages, loss of computation power, loss of access to data, etc., and the like. In the context of an enterprise security Al system, the sensed stimuli of interest include, but are not limited to, the level of repeat requests for certain databases in an enterprise, the number of times an external third-party program requests access to certain program modules in the enterprise's software system, etc., and the like.

Stimuli applied to an Al system may come in the form of a stressor, including external stressors referred to as externalities, on the system. Stressors on Al systems will generally include a new or unexpected or unpredictable input to the system. In some instances, a stressor may be an input to the system that the system has not previously encountered or otherwise been exposed to. For example, new inputs may vary and may include e.g., new data fed into or obtained by the system or new software introduced into the system, such as e.g., a software update. In some instances, a stressor may be an unexpected or unpredictable input to the system that the system either has or has not previously encountered or otherwise been exposed to. For example, unexpected and unpredictable inputs may vary and may include e.g., environmental inputs such as changes in the operating environment of a system that employs Al, data received at an unexpected time, or received data that falls outside of the normal range of data received by the Al system.

Al systems are, and the homeostatic capacity thereof is, not static and thus, the presence and/or absence of one or more stressors on the system may modulate the system, including modulating the homeostatic capacity of the system. For example, where a stressor is applied to an Al system the net result of the application of the stressor may be an increase in the homeostatic capacity of the system, including where the increase is detected through evaluation of the homeostatic capacity of the system as described herein. As another example, where a stressor is not applied, or an Al system is not exposed to a stressor, the homeostatic capacity of the system may not increase and may e.g., remain unchanged or decrease. In some instances, detection of unchanged or decreased homeostatic capacity of a system may be detected through evaluation of the homeostatic capacity of the system as described herein. In some instances, e.g., where a system does not receive a stressor over a period of time, an artificial stressor may be applied to the system, e.g., to test and/or increase the homeostatic capacity of the Al system.

Using the example of a loss of power as an input stimulus functioning as a stressor on an Al system, the Al system may detect the loss of power and adapt correspondingly. The loss of power may have not been previously encountered by the system or the loss of power may have been unpredicted (i.e., occurring at an unexpected time). Thus, the loss of power may function as new data applied to the Al system to which the system responds and adapts, resulting in a net increase in the homeostatic capacity of the Al system. Such a system, following adaptation to the new input, may have an increased capacity to maintain or return to normal functioning following future inputs or stressors, including where such future inputs or stressors do or do not include a loss of power component (i.e., include at least one different stressor as compared to the prior stressor). Accordingly, the homeostatic capacity of the Al system following the application or exposure to the stressor may be enhanced as compared to the homeostatic capacity of the system before application or exposure to the stressor. Before, during, and/or after stressor application/exposure, the homeostatic capacity of the system may be evaluated as described herein.

As summarized above, in some instances, an artificial stressor may be applied to an Al system. For example, in some instances, an Al system may be operably connected to an artificial stressor application module that applies a stressor to the Al system. Such a module may apply essentially any appropriate stressor in an artificial manner to the system, including e.g., where the stressor is one of those described herein applied in an artificial manner. For example, using the example of loss of power as above, in some instances, a system may artificially apply a loss of power to the system as a stressor to the Al system, e.g., to test the homeostatic capacity of the system and/or as a means of modulating the homeostatic capacity of the system.

The artificial stressor may be applied randomly, including e.g., where one or more of the amplitude, duration, frequency, type, etc. of the applied artificial stressor is selected and applied in a random manner. In some instances, the application of an artificial stressor may be employed when an Al system has operated for a period of time without exposure to or application of a stressor to the system and/or when the homeostatic capacity of the Al system is evaluated to be at a particular level, e.g., a baseline or decreased level. In some instances, an Al system, and/or a method of evaluating the homeostatic capacity of an Al system, may exclude the use of artificial stressors and/or a module that applies an artificial stressor.

A system with a high homeostatic capacity will have an enhanced ability to maintain normal operating performance in the presence of one or more stimuli, insults, and/or other actions on the system contributing to a change in a function of the system as compared to a system with low homeostatic capacity. Accordingly, a system with a low homeostatic capacity may be described as having a decreased ability to maintain normal operating performance in the presence of one or more stimuli, insults, and/or other actions on the system contributing to a change in a function of the system as compared to a system with high homeostatic capacity. In some instances, the homeostatic capacity of a system may increase or decrease after being subjected to one or more stimuli, insults, and/or other actions on the system. For example, in some instances, the homeostatic capacity of a system may decrease such that, after one or more stimuli, insults, and/or other actions on the system, the system is less capable of maintaining normal operating performance as compared to before the one or more stimuli, insults, and/or other actions on the system. In some instances, the homeostatic capacity of a system may increase such that, after one or more stimuli, insults, and/or other actions on the system, the system is more capable of maintaining normal operating performance as compared to before the one or more stimuli, insults, and/or other actions on the system.

Changes in homeostatic capacity after one or more stimuli, insults, and/or other actions on the artificial intelligence system, including increases and/or decreases in homeostatic capacity of the system, may be assessed using multiple evaluations of homeostatic capacity as described herein performed before, during and/or after one or more stimuli, insults, and/or other actions on the system. In some instances, homeostatic capacity may be constantly monitored before, during, and after one or more stimuli, insults, and/or other actions on the system. In some instances, the homeostatic capacity of a system after one or more stimuli, insults, and/or other actions on the system may represent an increase or decrease, as compared to the homeostatic capacity of the system before the one or more stimuli, insults, and/or other actions on the system, where such increase or decrease may range from at least 1% to at least 50%, including e.g., at least 1%, at least 5%, at least 10%, at least 20%, etc. For example, where a standardized task is employed, an evaluation described herein may reveal a 10% decrease in homeostatic capacity of the system after a stimulus as compared to completing the standardized task before the stimulus. In some instances, the homeostatic capacity of a system may be maintained before, during and/or after a stimulus, including e.g., where the evaluated homeostatic capacity is essentially equal at two assessed timepoints, one before the stimulus and one during or after the stimulus.

Dynamic functional data of interest also includes functional data that is obtained by evaluating a functional parameter for a change in response to withdrawal of a stimulus. Such functional data may include data that is obtained before and/or after withdrawal (e.g., blockage) of the stimulus to the system. In some instances, the functional data may be obtained over a given period of time that spans or follows the withdrawal of the stimulus to the system. This type of functional data may be viewed as functional data that is obtained over a given period of time in conjunction with withdrawal of a stimulus to the system being evaluated. The withdrawn stimulus may vary, where stimuli of interest include input stimuli and sensed stimuli. In the context of a computer assisted healthcare diagnostic Al system, input stimuli of interest include, but are not limited to, the lack of certain medical fields in a medical record system, the lack of proper input of medical data into the medical record system, etc., and the like. In the context of a computer assisted healthcare diagnostic Al system, sensed stimuli of interest include, but are not limited to, the improper categorization of certain medical procedures for medical billing purposes in which the description of the procedure does not match the billing code assigned to the procedure, etc., and the like.

A system with a high homeostatic capacity will have an enhanced ability to maintain normal operating performance after withdrawal of one or more stimuli contributing to a change in a function of the system as compared to a system with low homeostatic capacity. Accordingly, a system with a low homeostatic capacity may be described as having a decreased ability to maintain normal operating performance after withdrawal of one or more stimuli contributing to a change in a function of the system as compared to a system with high homeostatic capacity. The homeostatic capacity of a system may increase or decrease after withdrawal of one or more stimuli. For example, in some instances, the homeostatic capacity of a system may decrease such that, after withdrawal of one or more stimuli, the system is less capable of maintaining normal operating performance as compared to before the withdrawal of the one or more stimuli. In some instances, the homeostatic capacity of a system may increase such that, after withdrawal of one or more stimuli, the system is more capable of maintaining normal operating performance as compared to before withdrawal of the one or more stimuli.

In some instances, withdrawal of a stimulus may function as a stressor on the Al system such that, e.g., following withdrawal of the stimulus and adaptation of the Al system the net result is an increase in the homeostatic capacity of the system. In some instances, a lack of stimulus to an Al system may result in the homeostatic capacity of the system not increasing, including e.g., where the system does not receive a stimulus and the homeostatic capacity of the system remains the same or decreases over a period of time.

Changes in homeostatic capacity after withdrawal of one or more stimuli having an impact on the artificial intelligence system, including increases and/or decreases in homeostatic capacity of the system, may be assessed using multiple evaluations of homeostatic capacity as described herein performed before, during and/or after withdrawal of the one or more stimuli. In some instances, homeostatic capacity may be constantly monitored before, during, and after withdrawal of one or more stimuli. In some instances, the homeostatic capacity of a system after withdrawal of one or more stimuli may represent an increase or decrease, as compared to the homeostatic capacity of the system before withdrawal of the one or more stimuli, where such increase or decrease may range from at least 1% to at least 50%, including e.g., at least 1%, at least 5%, at least 10%, at least 20%, etc. For example, where a standardized task is employed, an evaluation described herein may reveal a 10% decrease in homeostatic capacity of the system at after withdrawal of a stimulus as compared to completing the standardized task before the stimulus was withdrawn. In some instances, the homeostatic capacity of a system may be maintained before, during and/or after withdrawal of a stimulus, including e.g., where the evaluated homeostatic capacity is essentially equal at two assessed timepoints, one before the stimulus was withdrawn and one during or after the stimulus was withdrawn.

Dynamic functional data of interest also includes functional data that is obtained by evaluating a functional parameter for a change in response to modulation of the contextual environment of the system. By contextual environment of the system is meant the perceived environment of the system. Such functional data may include data that is obtained before and/or after the modulation in the contextual environment of the system. In some instances, the functional data may be obtained over a given period of time that spans or follows the modulation of the contextual environment of the system. This type of functional data may be viewed as functional data that is obtained over a given period of time in conjunction with modulation of the contextual environment of the system. The modulation of the contextual environment of the system may vary, where contextual modulations of interest include, but are not limited to, change in day and night duration, change in temperature, change in humidity, change in elevation, change in atmosphere, change in direction, change in environmental biological and chemical levels, change in visual, auditory, olfactory, tactile, and gustatory related levels in the environment, and the like. Such modulations in contextual environment may represent stressors on the Al system where, e.g., following exposure to the change in contextual environment and adaption of the Al system the net result may be in an increase in the homeostatic capacity of the system.

A system with a high homeostatic capacity will have an enhanced ability to maintain normal operating performance after a modulation of the contextual environment that contributes to a change in a function of the system as compared to a system with low homeostatic capacity. Accordingly, a system with a low homeostatic capacity may be described as having a decreased ability to maintain normal operating performance after a modulation of the contextual environment that contributes to a change in a function of the system as compared to a system with high homeostatic capacity. In some instances, the homeostatic capacity of a system may increase or decrease after modulation of the contextual environment of the system. For example, in some instances, the homeostatic capacity of a system may decrease such that, after modulation of the contextual environment of the system, the system is less capable of maintaining normal operating performance as compared to before the modulation. In some instances, the homeostatic capacity of a system may increase such that, after modulation of the contextual environment of the system, the system is more capable of maintaining normal operating performance as compared to before the modulation.

Changes in homeostatic capacity after a modulation of the contextual environment of the system that has an impact on the artificial intelligence system, including increases and/or decreases in homeostatic capacity of the system, may be assessed using multiple evaluations of homeostatic capacity as described herein performed before, during and/or after such modulation. In some instances, homeostatic capacity may be constantly monitored before, during, and after modulation of the contextual environment of the system. In some instances, the homeostatic capacity of a system after modulation of the contextual environment of the system may represent an increase or decrease, as compared to the homeostatic capacity of the system before the modulation, where such increase or decrease may range from at least 1% to at least 50%, including e.g., at least 1%, at least 5%, at least 10%, at least 20%, etc. For example, where a standardized task is employed, an evaluation described herein may reveal a 10% decrease in homeostatic capacity of the system at after modulation of the contextual environment of the system as compared to before the modulation in completing the standardized task. In some instances, the homeostatic capacity of a system may be maintained before, during and/or after modulation of the contextual environment of the system, including e.g., where the evaluated homeostatic capacity is essentially equal at two assessed timepoints, one before the modulation of the contextual environment of the system and one during or after the modulation.

As reviewed above, a variety of different functional parameters may be measured to obtain the dynamic functional data. The method by which the functional data is obtained may vary depending on the nature of the functional parameter that is monitored. In some instances, the method employed to obtain the functional data includes monitoring the system to obtain the dynamic functional data. Any convenient protocol for monitoring a system for one or more of the above functional parameters may be employed.

Aspects of the methods further include evaluating the homoeostatic capacity of the system from the dynamic functional data. As such, following obtainment of the dynamic functional data, the homeostatic capacity of the system is evaluated based on the obtained dynamic functional data. Any convenient protocol may be employed to evaluate the homeostatic capacity of the system based on the obtained dynamic functional data. For example, the obtained dynamic functional data may be compared to control or reference sets of functional data to obtain the homeostatic capacity evaluation. In some instances, the obtained dynamic functional data may be compared to a suitable database of control or reference sets to obtain the homeostatic capacity evaluation. The control or reference sets of data may be made up of data obtained from multiple different systems of known homeostatic capacity. Any suitable comparison algorithm may be employed, and the output homeostatic capacity evaluation may be produced in a variety of different formats or configurations. This homeostatic capacity evaluation step may be performed using a suitable functional module of a computing device/system, e.g., as described in greater detail below.

The homeostatic capacity evaluation that is provided by methods of the invention may vary, as desired. For example, the evaluation may be an output in the form of a qualitative assessment, e.g., bad, poor, average, good and exceptional, etc. The output may be in the form of a quantitative assessment, e.g., where the homeostatic capacity evaluation output a number selected from a numerical scale. The homeostatic capacity evaluation output may provide assessment with respect to a number of different homeostatic capacity parameters, such as but not limited to: the robustness, dynamic range, resilience, adaptability, anti-fragility, etc., of the homeostatic capacity of the system.

The methods described herein may be employed with a variety of different types of artificial intelligence systems. As summarized above, artificial intelligence systems are systems that utilize data, algorithms, and computing to sense, learn, make decisions, and perform tasks. Artificial intelligence systems may include algorithms that apply a series of rules to make sense of structured inputs in the manner of a linear decision tree (expert systems) or algorithms that learn underlying statistical patterns to make predictions for novel data (machine learning). In certain embodiments, artificial intelligence systems include an artificial neural network with many layers through which data passes to spot sophisticated patterns (deep learning). In some cases, artificial intelligence systems are programmed to use feedback mechanisms to improve algorithms (reinforcement learning). In some instances, artificial intelligence systems are programmed to reuse the knowledge underpinning an algorithm in one domain to develop algorithms in another (transfer learning). Artificial intelligence systems may, e.g., categorize data, process sounds and images, and comprehend language and information. In some instances, the artificial intelligence system includes an artificial intelligence agent. An artificial intelligence agent is an autonomous entity that observes through sensors and acts upon an environment using actuators (i.e., it is an agent) and directs its activity towards achieving goals (e.g., it is “rational”).

Specific types of artificial intelligence systems include, but are not limited to: healthcare artificial intelligence systems; automotive artificial intelligence systems; financial artificial intelligence systems; gaming artificial intelligence systems; robotic artificial intelligence systems, business process artificial intelligence systems, including but not limited to: call center artificial intelligence systems, logistics artificial intelligence systems, manufacturing artificial intelligence systems, and control system artificial intelligence systems; and the like.

Healthcare artificial intelligence systems are systems that utilize artificial intelligence to improve patient outcomes or perform administrative and/or clinical healthcare functions. Artificial Intelligence in healthcare may improve the delivery of healthcare services by clinicians and empower laypersons to determine their own healthcare needs, evaluate the healthcare they receive from clinicians, and determine the healthcare services that lead to better healthcare outcomes. Healthcare artificial intelligence systems may be applied to, e.g., to the evaluation of patient data, robotic-assisted surgery, medical imaging and diagnostics, medical devices, drug discovery, patient monitoring, and personalized medicine. Artificial intelligence tools may also improve hospital workflows by offering assistance with non-patient care activities and improve patient care by providing virtual assistance, e.g., virtual nursing, that complements the services of healthcare providers.

As a non-limiting example, an Al system providing automated anesthesia may receive input(s) from one or more sensors in operable communication with a subject's cardiovascular system, including e.g., where analyzing data received from such inputs provides for an evaluation of the homeostatic capacity of the Al system. The Al system may receive input(s) from the sensor(s) during an abnormal or unexpected event, such as e.g., cardiac arrest, where such input(s) function as a stressor on the Al system. The system may respond with an output, including e.g., an indicator output (such as e.g., a warning light or warning indication on a display such as a screen) or an automated response (such as e.g., administration of a treatment to the subject, such as e.g., administration of an electrical charge such as that released by a defibrillator or administration of a pharmacological agent). The homeostatic capacity of the Al system may be enhanced following adaptation to the stressor, including e.g., where such an enhancement is evaluated according to the methods described herein.

Healthcare artificial intelligence systems are described in, e.g., U.S. Pat. Nos. 8,693,751; 9,922,291; 9,913,989; 9,911,045; 9,910,965; 9,901,705; 9,760,690; 9,408,537; 5,357,427; 9,901,252; 9,272,183; 8,712,510; 8,589,175; 8,525,666; 8,478,604; 8,392,152; 7,801,591; 7,218,964; and 9,881,134, each incorporated herein by reference. Healthcare artificial intelligence systems are further described in, e.g., U.S. Patent Application Nos. 20180068083; 20180039763; 20180018966; 20170360358; 20170319123; 20170308656; 20170185723; 20170147779; 20170098051; 20170068787; 20170011177; 20160335543; 20160259899; 20150081326; 20150006190; 20140297311; 20140046684; 20130332194; 20130218137; 20140316220; and 20130211421, each incorporated herein by reference.

Functional parameters of healthcare artificial intelligence systems include but are not limited to accuracy of diagnosis, accuracy of indicated treatment (including e.g., prescribed medication), positioning of a medical device or component thereof (e.g., surgical device, injection device, electrode, etc.), detection of adverse event(s), patient outcomes, (including e.g., survival rates, disease-free survival rates, readmittance rates, quality of life assessment, etc.), and the like. Such functional parameters may be evaluated before, during, and/or after a healthcare artificial intelligence system performs a task required of the system, and such evaluation may provide dynamic functional data for the healthcare artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a health care Al system, such as e.g., occurrence of an unexpected or unpredictable event, lack of data employed in a medical assessment (e.g., lack of patient survey data, lack of data used in a diagnostic context such as, biomarker data, imaging data, etc.), presence of conflicting patient and/or diagnostic data, an anatomical anomaly (e.g., absence of an expected anatomical structure, presence of an unexpected anatomical structure, abnormal position/shape/size of an anatomical structure, etc.), unexpected or unpredictable subject behavior, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

In some instances, a health care Al system may be employed to restore the homeostatic capacity of a biological system. For example, in some instances a health care Al system may receive and/or detect a stressor related to the biological system, such as but not limited to e.g., anaphylaxis, allergic reaction, vagal bias, atopy, etc., and create an output that restores the homeostatic capacity of the biological system, including e.g., where restoration of the homeostatic capacity of the biological system includes restoring autonomic balance (i.e., balance between the activities of the parasympathetic and sympathetic portions of the autonomic nervous system). Useful outputs for restoring the homeostatic capacity of a biological system include electrical and/or pharmacological modulations of the subject's autonomic nervous system, among others. In some instances, application of the stressor may modulate the homeostatic capacity of the health care Al system such that the homeostatic capacity of the Al system is changed following receiving and/or detecting the stressor. Such methods may also include evaluating the homeostatic capacity of the health care Al system, the homeostatic capacity of the biological system, or both, including where the evaluations include those Al system homeostatic capacity evaluations described herein. Non-limiting examples of assessments of biological system homeostatic capacity and modulations thereof include those described in US Patent Pub. Nos. 2015/0359888 A1, 2016/0256108 A1, 2018/0271440 A1, 2017/0150921 A1, and 2017/0150922 A1, the disclosures of which are incorporated herein by reference in their entirety.

Automotive artificial intelligence systems are systems incorporated in automotive hardware, software, and services that utilize artificial intelligence. The automotive industry has utilized artificial intelligence, soft computing, and other intelligent system technologies in domains like vehicle manufacturing, diagnostics, on-board systems, warranty analysis, and design. Automotive artificial intelligence systems may be utilized in, e.g., autonomous driving, identifying driving behaviors, driver monitoring, traffic optimization, personal assistants, and vehicle to infrastructure communication. Machine learning and data analytics may be further used in the automotive value chain.

As a non-limiting example, an Al system providing autonomous driving may receive input(s) from one or more sensors in operable communication with a navigation module of the system, including e.g., where analyzing data received from such inputs provides for an evaluation of the homeostatic capacity of the Al system. The Al system may receive input(s) from the sensor(s) during an abnormal or unexpected event, such as e.g., collision avoidance, where such input(s) function as a stressor on the Al system. The system may respond with an output, including e.g., an indicator output (such as e.g., a warning light or warning indication on a display such as a screen) or an automated response (such as e.g., providing a signal to the system indicating a deviation from the expected trajectory, instructing the system to correct the trajectory, etc.). The homeostatic capacity of the Al system may be enhanced following adaptation to the stressor, including e.g., where such an enhancement is evaluated according to the methods described herein.

Automotive artificial intelligence systems are described in, e.g., U.S. Pat. Nos. 9,429,943; 9,928,461; 9,919,648; 9,639,909; 9,163,909; 8,139,820; 5,841,949; and 5,555,495, each incorporated herein by reference. Automotive artificial intelligence systems are further described in, e.g., U.S. Patent Application Nos. 20180088574; 20180086264; 20180074502; 20180074501; 20170313248; 20170300059; 20170242436; 20170240110; 20170217367; and 20150012169, each incorporated herein by reference.

Functional parameters of automotive artificial intelligence systems include but are not limited to accuracy of navigation, accuracy of vehicle position, braking response, quality of vehicle assembly, etc. Such functional parameters may be evaluated before, during, and/or after an automotive artificial intelligence system performs a task required of the system, and such evaluation may provide dynamic functional data for the automotive artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on an automotive Al system, such as e.g., environmental conditions (e.g., abnormally low or high light, precipitation, extreme temperatures, etc.), unexpected or unpredictable events and/or objects (e.g., unexpected or unpredictable obstacles such as animals, pedestrians, etc., road construction, natural disasters, etc.), human input, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Financial artificial intelligence systems apply the tools of artificial intelligence to financial products, processes, and analysis in various aspects of finance, e.g., trading, risk management, and market research. Financial artificial intelligence systems may rely heavily on big data and may automate end-to-end processes, detect and prevent fraud, augment financial analytics, make predictions regarding effective trades, and support access to financial data among other functions. Financial artificial intelligence systems may include portfolio management systems, algorithmic trading systems, fraud detection systems, and loan/insurance underwriting systems. Financial artificial intelligence systems may further assess credit quality, price and sell insurance contracts, and automate client interaction.

As a non-limiting example, an Al system providing automated portfolio management may receive input(s) from a financial system, such as an electronic stock exchange, including e.g., where analyzing data received from such inputs provides for an evaluation of the homeostatic capacity of the Al system. The Al system may receive input(s) from the financial system during an abnormal or unexpected event, such as e.g., a catastrophic event, economic crisis, the collapse of a long-term speculative bubble, a worker strike, etc., where such input(s) function as a stressor on the Al system. The system may respond with an output, including e.g., an indicator output (such as e.g., a warning light or warning indication on a display such as a screen) or an automated response (such as e.g., initiating trades of financial instruments, freezing trades, etc.). The homeostatic capacity of the Al system may be enhanced following adaptation to the stressor, including e.g., where such an enhancement is evaluated according to the methods described herein.

Financial artificial intelligence systems are described, e.g., in U.S. Pat. Nos. 7,831,494; 7,818,233; 8,608,536; 7,113,932; 7,058,601; and 9,721,266, each incorporated herein by reference. Financial artificial intelligence systems are further described in, e.g., U.S. Patent Application Nos. 20020128950; 20160269378; 20090099884; 20060059073; 20030050814; 20050222929; and 20100191634, each incorporated herein by reference.

Functional parameters of financial artificial intelligence systems include but are not limited to trade frequency, yield, rate of return, accuracy of fraud detection (e.g., false positive rate, false negative rate, true positive rate, etc.), accuracy of financial predictions (e.g., accuracy of predicted future value, etc.), insurance metrics (average cost per claim, loss ratio, claim frequency, etc.), and the like. Such functional parameters may be evaluated before, during, and/or after a financial artificial intelligence system performs a task required of the system, and such evaluation may provide dynamic functional data for the financial artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a financial Al system, such as e.g., abnormally large market gains, abnormally large market losses, market volatility, introduction of new stocks or funds within a market, introduction of new financial instruments (e.g., new derivative investments) within a market, an abnormally high or low volume or trades/claims, an abnormally high or low frequency of trades/claims, rapid currency value changes (e.g., rapid inflation, rapid deflation, etc.), and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Gaming artificial intelligence systems are systems in which artificial intelligence is used to generate responsive, adaptive or intelligent behaviors, play a game, or enhance a game playing experience. Application areas for artificial intelligence in games include, but are not limited to, game-playing, content generation, and player modeling. The term “games” may refer to various types of games such as, e.g., board games and video games. In some cases, the systems are designed to generate intelligent behaviors in non-player characters. In some instances, a gaming artificial intelligence system includes a system designed for playing games with or without a learning component.

Gaming artificial intelligence systems are described, e.g., in U.S. Pat. Nos. 9,875,610; 8,911,296; and 8,858,313, each incorporated herein by reference. Gaming artificial intelligence systems are further described in U.S. Application Nos. 20080045343; 20120009997; and 20080207331, each incorporated herein by reference.

As a non-limiting example, an Al system providing automated content generation may receive input(s) from one or more sources such as player inputs, including e.g., where analyzing data received from such inputs provides for an evaluation of the homeostatic capacity of the Al system. The Al system may receive input(s) during an abnormal or unexpected event, such as e.g., abnormally rapid player input and/or simultaneous input from an abnormally large number of players, where such input(s) function as a stressor on the Al system. The system may respond with an output, including e.g., an indicator output (such as e.g., a warning light or warning indication on a display such as a screen) or an automated response (such as e.g., prioritization of inputs, reconfiguring of game content, such as player environments, etc.). The homeostatic capacity of the Al system may be enhanced following adaptation to the stressor, including e.g., where such an enhancement is evaluated according to the methods described herein.

Functional parameters of gaming artificial intelligence systems include but are not limited to time of play, player fulfillment, player acquisition (e.g., new users, daily active users, player initiated invites, etc.), player retention, player engagement, number of sessions per user, drop-off rates, session duration, level start metrics, level fail metrics, level complete metrics, game monetization metrics, and the like. Such functional parameters may be evaluated before, during, and/or after a gaming artificial intelligence system performs a task required of the system, and such evaluation may provide dynamic functional data for the gaming artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a gaming Al system, such as e.g., abnormal or unexpected player input, abnormal or unexpected number of players, abnormal duration of play, abnormal level starts/fails/completes, etc. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Robotic artificial intelligence systems are systems that may control a robot or be embodied in a robot. By “robot” is meant a mechanical system that may perceive its environment through sensors and then perform actions through actuators to carry out a task. In some cases, artificial intelligence software is implemented in a robotic system. Applications where robotics relies on artificial intelligence technologies include, but are not limited to, perception (e.g., computer vision), reasoning, learning (e.g., imitation learning, self-supervised learning, multi-agent learning), decision making, and human-robot interaction.

As a non-limiting example, an Al system providing automated computer vision may receive input(s) from one or more optical sensors that collect input from an environment, including e.g., where analyzing data received from such inputs provides for an evaluation of the homeostatic capacity of the Al system. The Al system may receive input(s) from the sensor(s) during an abnormal or unexpected event, such as e.g., the appearance of an unknown object or the unexpected disappearance of a reference, where such input(s) function as a stressor on the Al system. The system may respond with an output, including e.g., an indicator output (such as e.g., a warning light or warning indication on a display such as a screen) or an automated response (such as e.g., initiating further imaging of the unknown object or establishment of a new reference object within the environment). The homeostatic capacity of the Al system may be enhanced following adaptation to the stressor, including e.g., where such an enhancement is evaluated according to the methods described herein.

Robotic artificial intelligence systems are described in, e.g., U.S. Pat. Nos. 9,864,933; 9,601,104; 9,573,277; 9,548,050; 9,443,192; and 9,403,279, each incorporated herein by reference. Robotic artificial intelligence systems are further described in, e.g., U.S. Patent Application Nos. 20180035606; 20170008174; 20140372116; and 20130218137, each incorporated herein by reference.

Functional parameters of robotic artificial intelligence systems include but are not limited to accuracy of identification in computer vision applications, decision quality in Al decision applications, accuracy of robotic component positioning, accuracy of robot navigation, quality of robotic task performance, speed of robotic task performance, etc. Such functional parameters may be evaluated before, during, and/or after a robotic artificial intelligence system performs a task required of the system, and such evaluation may provide dynamic functional data for the robotic artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include environmental conditions (e.g., abnormally low or high light, precipitation, extreme temperatures, etc.), unexpected or unpredictable events and/or objects (e.g., unexpected or unpredictable obstacles such as animals, natural surfaces, etc.), human input, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Business process artificial intelligence systems enhance any business process conducted by an organization or help an organization achieve a business goal. Technologies that utilize machine learning may improve the detection of non-obvious patterns in data and facilitate the detection of deviating behavior, and in some cases, artificial intelligence is used to segment data for services in marketing applications. Business artificial intelligence systems further may provide modeling and simulation tools for understanding and predicting consumer behavior. Said systems may provide improved customer services, workload automation and predictive maintenance, effective data management and analytics.

As a non-limiting example, an Al system providing autonomous prediction of consumer behavior may receive input(s) from one or more data retrieval systems, including e.g., where analyzing data received from such inputs provides for an evaluation of the homeostatic capacity of the Al system. The Al system may receive input(s) during an abnormal or unexpected event, such as e.g., an unexpected or abnormal change in consumer demand, including e.g., order volume, order frequency, item views, etc. The system may respond with an output, including e.g., an indicator output (such as e.g., a warning light or warning indication on a display such as a screen) or an automated response (such as e.g., modifying a consumer behavior prediction algorithm, initiating a marketing response, etc.). The homeostatic capacity of the Al system may be enhanced following adaptation to the stressor, including e.g., where such an enhancement is evaluated according to the methods described herein.

Business process artificial intelligence systems are described in, e.g., U.S. Pat. Nos. 6,892,192; 6,112,190; 6,535,855; and 9,710,829, each incorporated herein by reference. Business process artificial intelligence systems are further described in, e.g., U.S. Patent Application Nos. 20170330205; 20170109657; 20160239770; 20030050814; 20040138936; 20040138934; and 20040138933; each incorporated herein by reference.

Functional parameters of business process artificial intelligence systems include but are not limited to quality of non-obvious pattern detection, quality of deviating behavior detection, accuracy of consumer behavior predictions, revenue outcomes related to Al driven marketing segmentation, performance of produced business models, performance of simulations as compared to observed data, and the like. Such functional parameters may be evaluated before, during, and/or after a business process artificial intelligence system performs a task required of the system, and such evaluation may provide dynamic functional data for the business process artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a business Al system, such as e.g., abnormal increases or decreases in product demand, rapid changes in customer behavior (such as e.g., abnormal responses to consumer directed marketing), rapid changes in consumer/customer populations, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Call center artificial intelligence systems utilize artificial intelligence to improve call center efficiency. Artificial intelligence technologies may augment the ability of call centers to predict queries (e.g., predict and analyze questions based on past activities of a customer), perform instant query handling irrespective of the time and location, and automate operations. Call center artificial intelligence systems may apply natural language processing technologies as well as big data analytics and machine learning to find patterns in customer call data and adapt to or anticipate various call situations.

As a non-limiting example, an Al system providing automating call center efficiency may receive input(s) from one or more data retrieval systems, including e.g., where analyzing data received from such inputs provides for an evaluation of the homeostatic capacity of the Al system. The Al system may receive input(s) during an abnormal or unexpected event, such as e.g., an unexpected or abnormal change in call center activity, including e.g., call volume, call duration, etc., or abnormal voice patterns. The system may respond with an output, including e.g., an indicator output (such as e.g., a warning light or warning indication on a display such as a screen) or an automated response (such as e.g., rerouting calls to a backup system, routing calls to a particular call center unit, modifying the call center user-interface, modifying the prompts presented to the user, etc.). The homeostatic capacity of the Al system may be enhanced following adaptation to the stressor, including e.g., where such an enhancement is evaluated according to the methods described herein.

Call center artificial intelligence systems are further described in e.g., U.S. Pat. Nos. 9,888,120; 9,622,061; 7,551,921; 8,521,677 and 7,395,056, each incorporated herein by reference. Call center artificial intelligence systems are further described in, e.g., U.S. Patent Application Nos. 20180020093; 20180097940; 20170339141; 20170293610; 20170249566, each incorporated herein by reference.

Functional parameters of call center artificial intelligence systems include but are not limited to call volume per unit time, customer hold time, customer satisfaction, call routing accuracy, call routing speed, and the like. Such functional parameters may be evaluated before, during, and/or after a call center artificial intelligence system performs a task required of the system, and such evaluation may provide dynamic functional data for the call center artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a call center Al system, such as e.g., abnormal (such as abnormally high or abnormally low) call volume, abnormal or extreme voice patterns, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Logistics artificial intelligence systems utilize artificial intelligence to optimize the operational efficiency and analytics of supply chain logistics. Logistics artificial intelligence systems may address industrial pain-points for customer value creation, improve productivity and assist in insight discovery in supply chain management. In some cases, logistics artificial intelligence systems are machine learning systems including, e.g., artificially intelligent supply chains or autonomous supply chains. Logistics artificial intelligence systems may be applied to manufacturing, warehousing, distribution, delivery or any process in a supply chain. In some cases, logistics artificial intelligence systems manage and analyze big data for an entire shipment lifecycle, optimize routes, provide insight into customers, carriers, and operations, and minimize operational delays.

As a non-limiting example, an Al system providing automated supply chain logistics may receive input(s) from various components of a supply chain, such as distribution and storage components, including e.g., where analyzing data received from such inputs provides for an evaluation of the homeostatic capacity of the Al system. The Al system may receive input(s) from the supply chain logistics system during an abnormal or unexpected event, such as e.g., a catastrophic event, abnormal order volume, abnormal orders (e.g., abnormal order destination, abnormal order item (including e.g., size, weight, and shape) etc., where such input(s) function as a stressor on the Al system. The system may respond with an output, including e.g., an indicator output (such as e.g., a warning light or warning indication on a display such as a screen) or an automated response (such as e.g., rerouting of one or more orders, accelerating or decelerating shipping requirements, freezing items at storage locations, etc.). The homeostatic capacity of the Al system may be enhanced following adaptation to the stressor, including e.g., where such an enhancement is evaluated according to the methods described herein.

Logistics artificial intelligence systems are described in U.S. Pat. Nos. 9,489,654; 8,239,229; 8,355,963; 8,577,733; and 9,922,345, each incorporated herein by reference and in U.S. Patent Application No. 20100241467, incorporated herein by reference.

Functional parameters of logistics artificial intelligence systems include but are not limited to accuracy of delivery, quality of delivery, utilization of storage capacity, utilization of shipping capacity, and the like. Such functional parameters may be evaluated before, during, and/or after a logistics artificial intelligence system performs a task required of the system, and such evaluation may provide dynamic functional data for the logistics artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a logistics Al system, such as e.g., abnormal or unexpected order volume, abnormal or unexpected desired shipping location, lack of storage capacity, lack of distribution capacity, insufficient manufacturing output, abnormal orders, human input, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Manufacturing artificial intelligence systems apply artificial intelligence technologies to increase the productivity of any step of a manufacturing process or the whole operation of manufacturing. Artificial intelligence may enhance material movement, predictive maintenance and machinery inspection, production planning, field services, reclamation, and quality control. Manufacturing artificial intelligence systems may further assist a manufacturing plant or factory operator in analysis of data generating by the plant or factory. In some cases, artificial intelligence may shorten design cycles, remove supply-chain bottlenecks, and reduce materials and energy waste by collecting data from all supply chain processes and detecting anomalies and failure situations. Artificial intelligence technologies for use in manufacturing include, but are not limited to, image recognition, data mining, and machine learning.

As a non-limiting example, an Al system providing automated quality control may receive input(s) from a manufacturing system, such as an optically-based quality control (QC) component of a manufacturing system, including e.g., where analyzing data received from such inputs provides for an evaluation of the homeostatic capacity of the Al system. The Al system may receive input(s) from the QC component during an abnormal or unexpected event, such as e.g., presence of an abnormal, expected or unpredictable object in the manufacturing system, an abnormal or unexpected rate of defects, etc., where such input(s) function as a stressor on the Al system. The system may respond with an output, including e.g., an indicator output (such as e.g., a warning light or warning indication on a display such as a screen) or an automated response (such as e.g., stopping a production line, slowing or increasing the rate of production, etc.). The homeostatic capacity of the Al system may be enhanced following adaptation to the stressor, including e.g., where such an enhancement is evaluated according to the methods described herein.

Manufacturing artificial intelligence systems are described in, e.g., U.S. Pat. Nos. 7,357,298; 7,401,728; 9,931,724; 9,904,896; 9,720,687; 9,745,081; 8,799,113; and 5,917,726, each incorporated herein by reference. Manufacturing artificial intelligence systems are further described in, e.g., U.S. Patent Application Nos. 20170278000 and 20020049625, each incorporated herein by reference.

Functional parameters of manufacturing artificial intelligence systems include but are not limited to production rate, defect rate, accuracy of required maintenance prediction, quality of production predictions, material consumption per unit, energy consumption per unit, and the like. Such functional parameters may be evaluated before, during, and/or after a manufacturing artificial intelligence system performs a task required of the system, and such evaluation may provide dynamic functional data for the manufacturing artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a manufacturing Al system, such as e.g., variations and/or changes in raw materials, changes in production rates, changes in environmental conditions (e.g., abnormally low or high light, humidity, extreme temperatures, etc.), human inputs, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Control system artificial intelligence systems utilize artificial intelligence to control dynamic systems. Approaches to developing artificial intelligence in control systems include, e.g., statistical methods, computational intelligence, and traditional symbolic artificial intelligence. In some cases, artificial intelligence may be used to control dynamic physical systems that must respond to changes in environments, disturbances, and changing reference models, performance criteria or component failures. Artificial intelligence computing approaches include, but are not limited to, knowledge-based systems, automatic knowledge acquisition, case-based reasoning, ambient-intelligence, neural networks, Bayesian probability, fuzzy logic, machine learning, evolutionary computation, genetic algorithms.

As a non-limiting example, an Al system providing automated climate control may receive input(s) from one or more sensors in operable communication with a system that modulates the relevant climate, including e.g., where analyzing data received from such inputs provides for an evaluation of the homeostatic capacity of the Al system. The Al system may receive input(s) from the sensor(s) during an abnormal or unexpected event, such as e.g., abnormally high or abnormally low temperatures, abnormally high/low humidity, etc. The system may respond with an output, including e.g., an indicator output (such as e.g., a warning light or warning indication on a display such as a screen) or an automated response (such as e.g., initiating a climate control response, such as initiating a heating and/or cooling device). The homeostatic capacity of the Al system may be enhanced following adaptation to the stressor, including e.g., where such an enhancement is evaluated according to the methods described herein.

Control system artificial intelligence systems are described in, e.g., U.S. Pat. Nos. 9,916,538, 9,798,751; 6,289,331; and 5,291,390, each incorporated herein by reference. Control system artificial intelligence systems are further described in, e.g., U.S. Patent Application Nos. 20170221152 and 20060155398, incorporated herein by reference.

Functional parameters of control system artificial intelligence systems include but are not limited to accuracy of system in achieving setpoint or target, deviation from setpoint or target (e.g., over a given period of time), frequency of deviations outside of established range (e.g., over a given period of time), quality of predictive models, user feedback, and the like. Such functional parameters may be evaluated before, during, and/or after a control system artificial intelligence system performs a task required of the system, and such evaluation may provide dynamic functional data for the control system artificial intelligence system employed in making a determination of the homeostatic capacity of the system. In some instances, the homeostatic capacity of the system may be assessed before, during, and/or after the system is subjected to one or more inputs, including e.g., insults, stimuli, stimulus withdrawals, changes in environmental context, or factors that change over time that may be expected to influence the homeostatic capacity of the system. Non-limiting examples of such inputs include stressors on a Al control system, such as e.g., abnormal or extreme environmental conditions (e.g., abnormally low or high light, humidity, extreme temperatures, etc.), changes in the system components be controlled, changes in the control parameters (including targets and/or setpoints), system updates, human inputs, and the like. Following the assessment, an output may result in the form of a determination about the system's homeostatic capacity, including e.g., a determination of whether homeostatic capacity has increased, decreased or been maintained, and/or a classification of the homeostatic capacity of the system, e.g., based on one or more classification rules or analyses.

Examples of artificial intelligence applications include, but are not limited to: data security applications (e.g., Al applications that detect malware), personal security applications (e.g., Al applications that are employed in security systems at airports, stadiums, concerts, and other venues), financial trading applications (e.g., Al applications that predict and execute trades at high speeds and high volume); healthcare applications (e.g., Al applications for computer assisted diagnosis (CAD) and Al applications to understand risk factors for disease in large populations), marketing personalization applications (e.g., Al applications that personalize marketing, such as which emails a customer receives, which direct mailings or coupons, which offers they see, which products show up as “recommended” and so on, all designed to lead the consumer more reliably towards a sale), fraud detection applications (e.g., Al applications that identify potential cases of fraud across many different fields, such as money laundering), recommendation applications, e.g., (Al applications that analyze user activity and compare it to millions of other users to determine to identify what a user might like to buy or binge watch), online search applications, (e.g., Al applications employed in search engines), natural language processing (NLP) applications (e.g., Al applications employed as customer service agents); smart transportation applications (e.g., Al applications employed in autos and trucks), smart health monitoring applications, (e.g., Al applications employed in in mobile devices, implanted devices and in-home and in-office devices that monitor and alert a person to his or her health status and notifies relatives and healthcare service providers), banking applications, energy applications, fintech applications, insurance applications, public sector applications, etc.

In some embodiments, the methods may further include modulating the homoeostatic capacity of the system following obtainment of the homeostatic capacity evaluation of the system. For example, the methods may include modulating the homeostatic capacity of the system to that of a target homeostatic capacity. By “target homeostatic capacity” is meant a certain level of homeostatic capacity outcome desired based on measurements of various parameters. Such a level could be based on a scoring system, a threshold value or composite of values, the ability to achieve a certain desired performance or outcome of the Al algorithm or system, etc.

Modulation of the homeostatic capacity of a system as described above can be achieved using any suitable protocol, including, but not limited to changing a software component of the artificial intelligence system and/or changing a hardware component of the artificial intelligence system. In some instances, modulation may involve increasing the homeostatic capacity a system that is determined to have a low homeostatic capacity, e.g., as compared to a corresponding or reference system. In some instances, modulation may involve increasing the homeostatic capacity a system that is determined to have a decreased homeostatic capacity, e.g., as compared to the same system as assessed previously, including e.g., at an earlier timepoint and/or before being subjected to a stimulus, insult, contextual change, or withdrawal of a stimulus. In some instances, modulation may involve instituting a protocol to maintain the homeostatic capacity of the system, e.g., at a reference level or following an assessed decrease in homeostatic capacity.

In some instances, the methods may include use of one or more static measures of homeostatic capacity. Such measures may be used as separate measures, or composites of dynamic and static measurements may be employed. In some instances, methods may exclude the use of static measures, including only dynamic measures.

### Utility

The subject methods find use in a variety of different applications. Applications of interest include, but are not limited to: performance monitoring applications; diagnostic applications; preventative applications; homeostatic capacity modulation applications diagnostic and performance optimization and minimization applications etc.

### Devices and Systems

A number of different devices and systems may be employed in accordance with the subject invention. Devices and systems that may be adapted or configured for use in the subject invention include devices and systems for obtaining dynamic functional data from a system and optionally further processing the obtained data in some instances, e.g., in making a homeostatic capacity evaluation of the system based on the obtained dynamic functional data, etc. In some instances, the device may be configured to also adjust a system based on the homeostatic capacity evaluation.

Devices of interest may include one or more functional modules, which may be distributed among two or more distinct hardware units or integrated into a single hardware unit, e.g., as described in greater detail below. In some instances, the devices include a dynamic functional data obtainment module, a homeostatic capacity evaluation module, and a homeostatic capacity evaluation output module. The dynamic functional data obtainment module is adapted to obtain dynamic functional data, e.g., by being in operational communication with one or more functional parameter sensors and or an input configured to receive dynamic functional data from a source of such data, and transmit the obtained functional data to the process unit module. The homeostatic capacity evaluation module is adapted to retrieve the dynamic functional data from the dynamic functional data obtainment module and make a homeostatic capacity evaluation therefrom. As such, the module is configured to produce a homeostatic capacity evaluation from the received or input dynamic functional data. In some instances, the systems further include an adjustment module, which is configured to identify a suitable adjustment based on the homeostatic capacity evaluation. The output module may be adapted to provide the homeostatic capacity evaluation (and in some instances an adjustment) to a user, e.g., the subject or interested stakeholder. In some instances, the output module is configured to display the homeostatic capacity evaluation to a user, e.g., via graphical user interface (GUI). In one embodiment, a visual display can be used for displaying the homeostatic capacity evaluation. Other outputs may also be employed, e.g., printouts, messages (e.g., text messages or emails) sent to another display device, to a storage location for later viewing (e.g., the cloud), etc.

One embodiment of a device for evaluating a system's homeostatic capacity is configured as follows. A dynamic functional data obtainment module is configured to obtain the system's dynamic functional data. This functional data from the system may then be input into a homeostatic capacity evaluation module, along with functional data from a database, which contains data made up from systems of a variety of different known homeostatic capacities. The homeostatic capacity evaluation module evaluates the system's homeostatic capacity based on the functional data from the system and from the database using a classification rule derived from a machine learning algorithm, which may be any convenient algorithm, such as but not limited to: Fisher's linear discriminant, logistic regression, naïve Bayes classifier, quadratic classifiers, k-nearest neighbor, decision trees, neural networks, and support vector machine. The homeostatic capacity evaluation module may then output the system's predicted homeostatic capacity in a user-readable format via a homeostatic capacity evaluation output module.

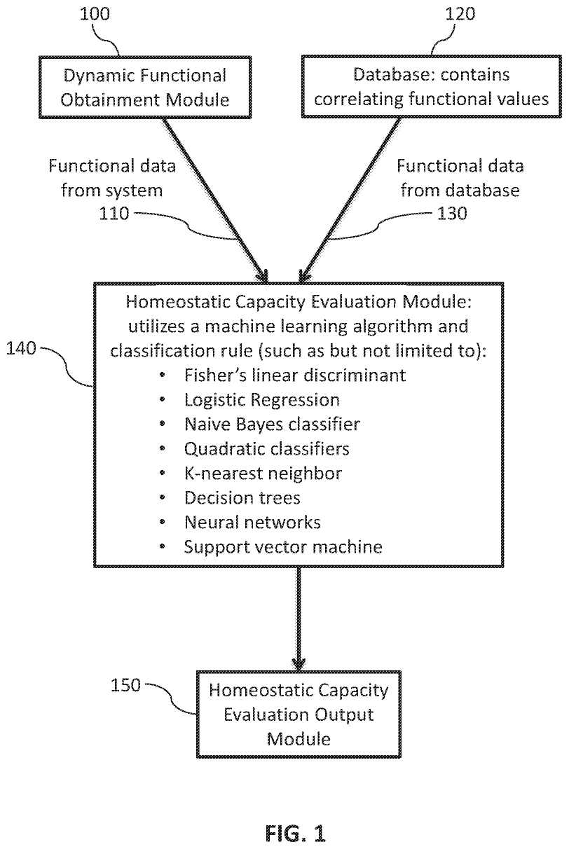

An example of a device according to an embodiment of the invention as described above is illustrated in the flow chart of FIG. 1. Dynamic functional obtainment module 100 is adapted to obtain a system's dynamic functional data 110. This functional data 110 from the system is then input into the homeostatic capacity evaluation module 140, along with functional data 130 from a database 120. The database 120 contains data made up from systems of a variety of known homeostatic capacities. The homeostatic capacity evaluation module 140 evaluates the system's homeostatic capacity based on the functional data from the system 110 and from the database 130 using a classification rule derived from a machine learning algorithm, which may be any convenient algorithm, such as but not limited to: Fisher's linear discriminant, logistic regression, naïve Bayes classifier, quadratic classifiers, k-nearest neighbor, decision trees, neural networks, and support vector machine. The homeostatic capacity evaluation output module 150 then provides the homeostatic capacity evaluation to the user.

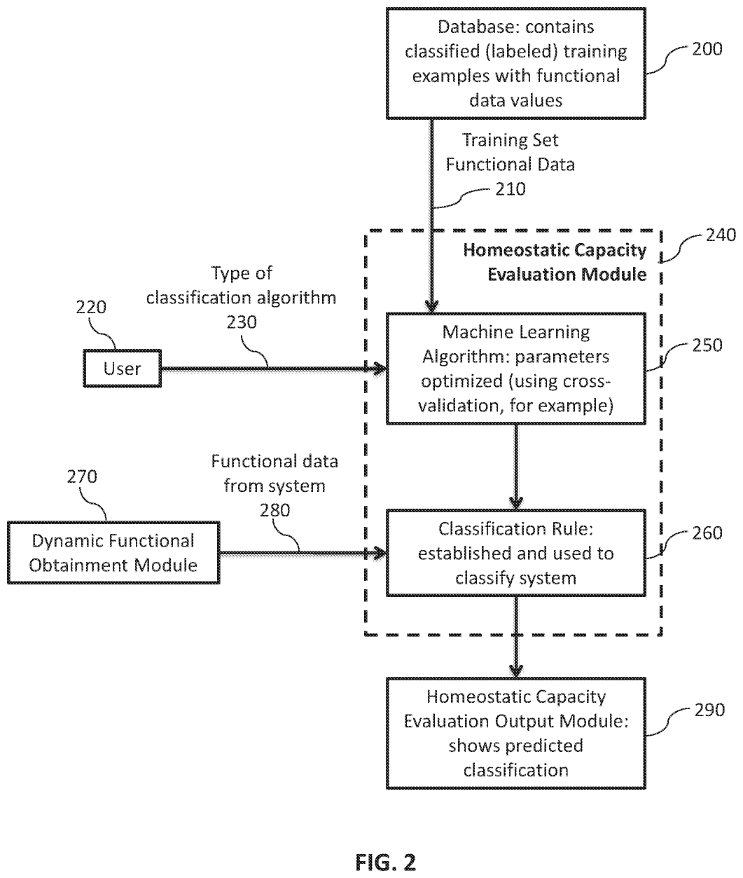

FIG. 2 illustrates aspects of the device of FIG. 1 in greater detail, including implementation of a machine learning algorithm in order to classify systems according to their homeostatic capacities. Functional data comprising a training set 210 is obtained from a database 200, which contains classified or labeled, training examples with functional values. In other words, database 200 has functional data from systems of known homeostatic capacities. The training set functional data 210 is input into a machine learning algorithm 250 of a homeostatic capacity evaluation module 240. A user 220 may define the type of classification/machine learning algorithm 230 to be used. The machine learning algorithm 250 is optimized using one of a variety of statistical means known in the art, such as cross-validation. Alternatively (not shown), the user may define a plurality of machine learning algorithms, or the computer may define a plurality of machine learning algorithms, for which optimization methods will be performed and the best (most accurate) will be used. Once the machine learning algorithm 250 is optimized, a classification rule 260 is established. Dynamic functional obtainment module 270 is adapted to obtain the system's dynamic functional data 280. This functional data 280 from the system is then input into the classification rule 260 of the homeostatic capacity evaluation module 240. The system's homeostatic capacity is evaluated using the classification rule 260. The predicted homeostatic capacity classification/evaluation is provided to the user by the homeostatic capacity evaluation output module 290.

As would be recognized by one of skilled in the art, many different software, firmware, hardware options and data structures can be employed in devices of the invention, e.g., as described above. In some instances, a general-purpose computer can be configured to a functional arrangement for the methods and programs disclosed herein. The hardware architecture of such a computer is well known by a person skilled in the art, and can comprise hardware components including one or more processors (CPU), a random-access memory (RAM), a read-only memory (ROM), an internal or external data storage medium (e.g., hard disk drive). A computer system can also comprise one or more graphic boards for processing and outputting graphical information to display means. The above components can be suitably interconnected via a bus inside the computer. The computer can further comprise suitable interfaces for communicating with general-purpose external components such as a monitor, keyboard, mouse, network, etc. In some embodiments, the computer can be capable of parallel processing or can be part of a network configured for parallel or distributed computing to increase the processing power for the present methods and programs. In some embodiments, the program code read out from the storage medium can be written into a memory provided in an expanded board inserted in the computer, or an expanded unit connected to the computer, and a CPU or the like provided in the expanded board or expanded unit can actually perform a part or all of the operations according to the instructions of the program code, so as to accomplish the functions described below. In other embodiments, the method can be performed using a cloud computing system. In these embodiments, the datafiles and the programming can be exported to a cloud computer, which runs the program, and returns an output to the user.

The memory of a computer system can be any device that can store information for retrieval by a processor, and can include magnetic or optical devices, or solid-state memory devices (such as volatile or non-volatile RAM). A memory or memory unit can have more than one physical memory device of the same or different types (for example, a memory can have multiple memory devices such as multiple drives, cards, or multiple solid-state memory devices or some combination of the same). With respect to computer readable media, “permanent memory” refers to memory that is permanent. Permanent memory is not erased by termination of the electrical supply to a computer or processor. Computer hard-drive ROM (i.e., ROM not used as virtual memory), CD-ROM, floppy disk and DVD are all examples of permanent memory. Random Access Memory (RAM) is an example of non-permanent (i.e., volatile) memory. A file in permanent memory can be editable and re-writable. Operation of the computer is controlled primarily by operating system, which is executed by a central processing unit. The operating system can be stored in a system memory. In some embodiments, the operating system includes a file system. In addition to the operating system, one possible implementation of the system memory includes a variety programming files and data files for implementing the method described above.

Where desired, the devices may include one or more sensors, e.g., configured to obtain functional data, e.g., as described above. Sensors of interest include, but are not limited to: accelerometers, gyroscopes, video image capturing devices, optical image sensors, audio capturing devices, biometric sensors (such as blood pressure monitors, glucose level monitors, heart rate variability monitors, bioelectric measurement devices, etc.), software and hardware security and monitoring devices, etc.

In use, dynamic functional data information is input into the system, and a user receives a homeostatic capacity evaluation from the system, e.g., as described above. In certain embodiments, instructions in accordance with the method (e.g., in the form of a mobile app or other type of structure) described herein can be coded onto a computer-readable medium in the form of “programming”, where the term “computer readable medium” as used herein refers to any storage or transmission medium (including non-transitory versions of such) that participates in providing instructions and/or data to a computer for execution and/or processing. Programming may take the form of any convenient algorithms. In some instances, programming may include statistical analysis. Any of a variety of statistical methods known in the art and described herein, can be used, where statistical methods of interest include, for example, discriminant analysis, classification analysis, cluster analysis, analysis of variance (ANOVA), regression analysis, regression trees, decision trees, nearest neighbor algorithms, principal components, factor analysis, ensemble learning, AdaBoost, ALOPEX, analogical modeling, cascading classifiers, case-based reasoning, classifier chains, co-training, information fuzzy networks, logic learning machine, perceptron, multidimensional scaling and other methods of dimensionality reduction, likelihood models, hypothesis testing, kernel density estimation and other smoothing techniques, cross-validation and other methods to guard against overfitting of the data, the bootstrap and other statistical resampling techniques, artificial intelligence, including artificial neural networks, machine learning, data mining, and boosting algorithms, and Bayesian analysis, etc.

Examples of storage media include a floppy disk, hard disk, optical disk, magneto-optical disk, CD-ROM, CD-ft magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer. The computer-implemented method described herein can be executed using programming that can be written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as any many others.

As mentioned above, the functional modules may be performed by a variety of different hardware, firmware and software configurations. In some instances, the functional modules will be distributed among a system of two or more distinct devices, e.g., mobile devices, remote devices (such as cloud server devices), laboratory instrument devices, etc., which may be in communication with each other, e.g., via wired or wireless communication. In other instances, the distinct functional modules will be integrated into a single device. Where the distinct functional modules are integrated into a single device, the device may have a variety of configurations. For example, the device may be a laboratory device, which may or may not be configured to a bench top device. In yet other instances, the device may be a handheld device, e.g., a smartphone or tablet type device. In yet other instances, the device may be a wearable device, such as a watch type device, a wearable patch type device, etc.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A method of evaluating homoeostatic capacity of an artificial intelligence system, the method comprising:
obtaining dynamic functional data from the artificial intelligence system; and
evaluating the homoeostatic capacity of the artificial intelligence system from the dynamic functional data.

2. The method according to claim 1, wherein the dynamic functional data comprises functional data obtained over a period of time.

3. The method according to claim 2, wherein the functional data is continuously obtained over the period of time.

4. The method according to claim 1, wherein the dynamic functional data is obtained by evaluating a functional parameter for a change in response to one or more of an applied stimulus, a withdrawal of a stimulus and a change in contextual environment.

5. The method according to claim 4, wherein the applied stimulus comprises an input stimulus.

6. The method according to claim 4, wherein the applied stimulus comprises a sensed stimulus.

7. The method according to claim 1, wherein the dynamic functional data is obtained by evaluating a functional parameter for a rate of change over a period of time.

8. The method according to claim 1, wherein the method comprises monitoring the artificial intelligence system to obtain the dynamic functional data.

9. The method according to claim 1, wherein the artificial intelligence system is a healthcare artificial intelligence system.

10. The method according to claim 1, wherein the artificial intelligence system is an automotive artificial intelligence system.

11. The method according to claim 1, wherein the artificial intelligence system is a financial artificial intelligence system.

12. The method according to claim 1, wherein the artificial intelligence system is a gaming artificial intelligence system.

13. The method according to claim 1, wherein the artificial intelligence system is a robotic artificial intelligence system.

14. The method according to claim 1, wherein the artificial intelligence system is business process artificial intelligence system.

15-18. (canceled)

19. The method according to claim 1, wherein the artificial intelligence system comprises an artificial intelligence agent.

20. The method according to claim 1, wherein the method further comprises adjusting the artificial intelligence system to modulate the homoeostatic capacity of the artificial intelligence system.

21. The method according to claim 20, wherein the homeostatic capacity of the artificial intelligence system is modulated to approximate that of a target homeostatic capacity.

22. The method according to claim 20,
wherein the adjusting comprises changing a software and/or hardware component of the artificial intelligence system.

23. (canceled)

24. A system configured to evaluate homoeostatic capacity of an artificial intelligence system, the system comprising:
an input module for receiving dynamic functional data from the artificial intelligence system;
a homeostatic capacity evaluation module configured to evaluate the homoeostatic capacity of the artificial intelligence system from input dynamic functional data; and
an output module configured to provide a homeostatic capacity evaluation of an artificial intelligence system.

25-34. (canceled)

35. A system configured to modulate the homoeostatic capacity of an artificial intelligence system, the system comprising:
an input module for receiving a homeostatic capacity evaluation for the artificial intelligence system; and
an adjustment module for adjusting the artificial intelligence system to modulate the homoeostatic capacity of the artificial intelligence system.

36-40. (canceled)
